(19) United States
(12) Patent Application Publication
(10) Pub. No.: US 2012/0254529 A1
(43) Pub. Date: Oct. 4, 2012

(54) MOTHERBOARD WITH DDR MEMORY DEVICES

(75) Inventor: LI-YONG WANG, Wuhan (CN)

(73) Assignees: HON HAI PRECISION INDUSTRY CO., LTD., Tu-Cheng (TW); HONG FU JIN PRECISION INDUSTRY (WUHAN) CO., LTD., Wuhan City (CN)

(21) Appl. No.: 13/298,372

(22) Filed: Nov. 17, 2011

(30) Foreign Application Priority Data
Mar. 31, 2011 (CN) 201110080360.3

(51) Int. Cl. G06F 13/00; G06F 12/00

(52) U.S. Cl. 711/105; 710/100

(57) ABSTRACT

A motherboard includes a central processing unit (CPU) with a reset signal output pin, a buffer circuit, and at least one memory device. The buffer circuit includes an input terminal connected to the reset signal output pin of the CPU and at least one output terminal. The input terminal and the at least one output terminal have the same voltage level. The at least one memory device has a reset signal receiving terminal connected to the at least one output terminal of the buffer circuit.

### BACKGROUND

1. Technical Field

The present disclosure relates to motherboards with double data rate (DDR) memory devices.

2. Description of Related Art

In a computer system, one or more DDR memory devices may be installed on a motherboard. To save energy, a reset signal can be sent from a central processing unit (CPU) of the motherboard to the one or more DDR memory devices to cease functioning when not needed. Each of the DDR memory devices may include a reset signal receiving terminal connected to a reset signal output pin of the CPU. However, other signals of the motherboard can interfere with the reset signals. Thus, the level of the signal received at the reset signal receiving terminal may not be the same as that sent from the CPU, which can cause the one or more DDR memory devices to respond incorrectly.

Therefore, there is room for improvement within the art.

### BRIEF DESCRIPTION OF THE DRAWINGS

Many aspects of the embodiments ca be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a motherboard with DDR memory devices.

FIG. 2 is a detailed diagram of a buffer circuit of the motherboard of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

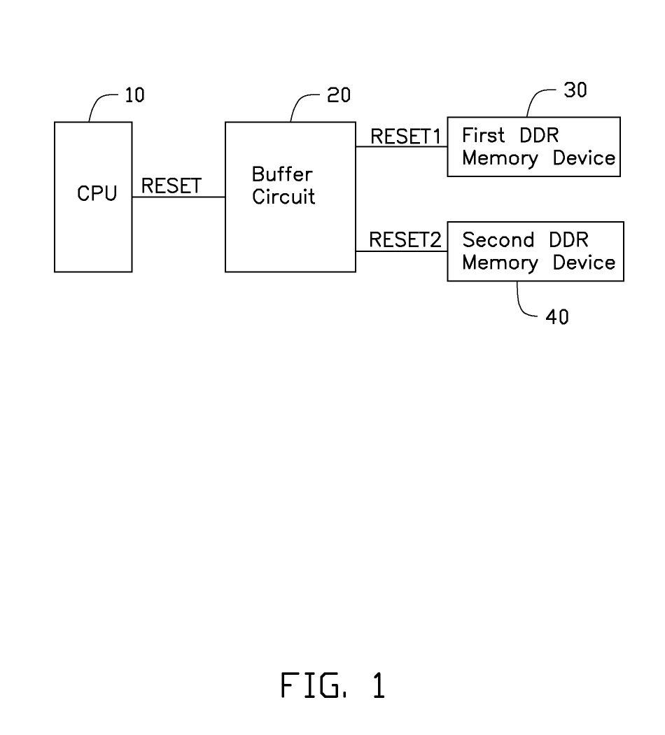

Referring to FIG. 1, an embodiment of a motherboard includes a CPU 10, a buffer circuit 20, a first DDR memory device 30, and a second DDR memory device 40. An input terminal of the buffer circuit 20 is connected to a reset signal output pin (hereinafter “RESET pin”) of the CPU 10. A first output terminal of the buffer circuit 20 is connected to a first reset signal receiving pin (hereinafter “RESET1pin”) of the first DDR memory device 30. A second output terminal of the buffer circuit 20 is connected to a second reset signal receiving pin (hereinafter “RESET2 pin”) of the second DDR memory device 40.

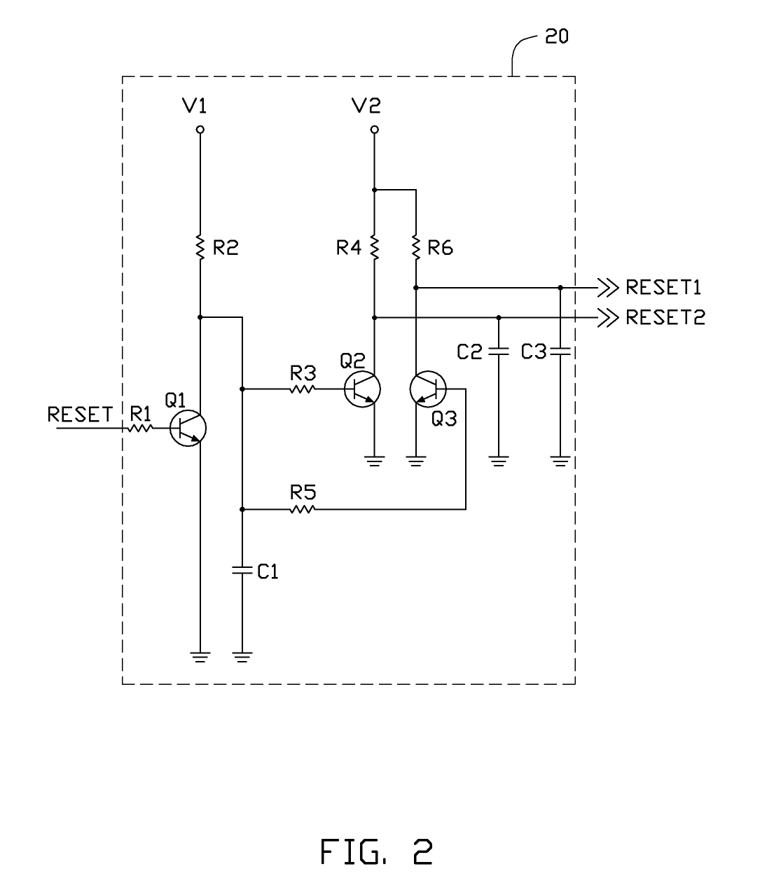

Referring to FIG. 2, the buffer circuit 20 may include a first transistor Q1, second transistor Q2, a third transistor Q3, a first resistor R1, a second resistor R2, a third resistor R3, a fourth resistor R4, a third resistor R5, a sixth resistor R6, a first capacitor C1, a second capacitor C2, and a third capacitor C3. Transistors Q1, Q2, and Q3 are all npn-type bipolar transistors and can function as switches. A base of the first transistor Q1 is connected to the RESET pin via the first resistor R1. A collector of the first transistor Q1 is coupled to a first power supply V1 via the second resistor R2. In one embodiment, the first power supply V1 is a 3.3 volt (V) standby power supply. An emitter of the first transistor Q1 is connected to ground. The collector of the first transistor Q1 is connected to ground via the first capacitor C1. A base of the second transistor Q2 is connected to the first collector of Q2 via the third resistor R3. A collector of the second transistor Q2 is coupled to a second power supply V2 via the fourth resistor R4. In one embodiment, the second power supply is a 1.5V power supply. An emitter of the second transistor Q2 is connected to ground. The collector of Q2 is connected to ground via the second capacitor C2. A base of the third transistor Q3 is connected to the collector of Q1 via the fifth resistor R5. A collector of the third transistor Q3 is coupled to the second power supply via the sixth resistor R6. An emitter of the third transistor Q3 is connected to ground. The collector of Q3 is connected to the third capacitor C3. The collector of Q2 is connected to the RESET2 pin. The collector of Q3 is connected to the RESET1 pin.

If the voltage level of the signal at the RESET pin is at a high level, the first transistor Q1 is rendered conductive. The collector of Q1 is connected to ground and at a low level. In transistor-transistor logic (TTL) circuits, a high level voltage is a voltage greater than a first voltage threshold (e.g., 2.4V), and a low level voltage is a voltage less than a second voltage threshold (e.g., 0.4V). In one embodiment, the high level voltage is greater than a threshold voltage of each of the transistor Q1, Q2, Q3. The low level voltage is less than the threshold voltage of each of the transistor Q1, Q2, Q3. The bases of Q2 and Q3 are at the low level. The second transistor Q2 and the third transistor Q3 are rendered non-conductive. The collectors of Q2 and Q3 are at the high level. Thus, the signals at the RESET1 pin and RESET2 pin are at the high level which is consistent with the high level signal at the RESET pin.

If the signal at the RESET pin is at the low level, the first transistor Q1 is rendered non-conductive. The collector of Q1 is at the high level. The bases of Q2 and Q3 are at the high level. The second transistor Q2 and the third transistor Q3 are rendered conductive. The collectors of Q2 and Q3 are connected to ground and at the low level. Thus, signals at the RESET1 pin and RESET2 pin are at the low level which is consistent with the low level signal at the RESET pin.

Due to the buffer circuit 20, reset signals received by the first DDR memory device 30 and the second DDR memory device 40 are consistent with the reset signals sent from the CPU 10 regardless of any signal interference. Thus, the first DDR memory device 30 and the second DDR memory device 40 can respond to the reset signals sent from the CPU 10.

In one embodiment, the buffer circuit 20 utilizes other switch components, such as field effect transistors, instead of the npn-type bipolar transistors. In other embodiments, the buffer circuit 20 sends one or more reset signals to one or more DDR memory devices installed on the motherboard.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A motherboard comprising:
a central processing unit (CPU) comprising a reset signal output pin;
a buffer circuit comprising an input terminal and at least one output terminal, the input terminal being connected to the reset signal output pin, and a voltage on the at least one output terminal being consistent with that on the input terminal; and
at least one memory device with a reset signal receiving pin connected to the at least one output terminal.

2. The motherboard of claim 1, wherein the buffer circuit further comprises a first transistor connected to the reset signal output pin via the input terminal, and a second transistor connected to the at least one memory device via the at least one output terminal; the second transistor is connected to the first transistor.

3. The motherboard of claim 2, wherein the first transistor comprises a first base terminal connected to the reset signal output pin via the input terminal, a first collector terminal connected to a first power source, and a first emitting terminal connected to ground.

4. The motherboard of claim 3, wherein the second transistor comprises a second base terminal connected to the first collector terminal, a second collector terminal coupled to a second power source, and a second emitting terminal connected to ground.

5. The motherboard of claim 4, wherein the buffer circuit further comprises a first capacitor connected to the first collector terminal, and a second capacitor connected to the second collector terminal.

6. The motherboard of claim 2, wherein each of the first transistor and the second transistor is an npn-type bipolar transistor.

7. The motherboard of claim 2, wherein each of the first transistor and the second transistor is a field effect transistor.

8. The motherboard of claim 1, wherein the at least one memory device is a double data rate memory device.

9. A motherboard comprising:
a central processing unit (CPU) with a reset signal outputting pin outputting a reset signal at a high voltage level or a low voltage level; wherein the high voltage level is greater than a first threshold level, and the low voltage level is less than a second threshold level; and the second threshold level is less than the first threshold level;
a buffer circuit comprising an input terminal connected to the reset signal outputting pin, and a first output terminal; the input terminal and the first output terminal having the same voltage level as the reset signal; and
a first memory device with a first reset signal receiving pin connected to the first output terminal.

10. The motherboard of claim 9, wherein the buffer circuit comprises a first transistor connected to the CPU, and a second transistor connected to the first memory device; and the second transistor is connected to the first transistor.

11. The motherboard of claim 10, wherein the first transistor comprises a first base terminal connected to the reset signal outputting pin, a first collector terminal connected to a first power source, and a first emitting terminal connected to ground.

12. The motherboard of claim 11, wherein the second transistor comprises a second base terminal connected to the first collector terminal, a second collector terminal coupled to a second power source, and a second emitting terminal connected to ground.

13. The motherboard of claim 12, further comprising a second memory device with a second reset signal receiving pin, wherein the buffer circuit further comprises a second output terminal connected to the second reset signal receiving pin, wherein the second output terminal has the same voltage level as the reset signal.

14. The motherboard of claim 13, wherein the buffer circuit further comprises a third transistor connected to the CPU and the second memory device.

15. The motherboard of claim 14, wherein the third transistor comprises a base terminal connected to the first collector terminal, a third collector terminal connected to the second power source, and a third emitting terminal connected to ground.

16. The motherboard of claim 15, wherein each of the first transistor, the second transistor, and the third transistor is an npn-type bipolar transistor.

17. The motherboard of claim 13, wherein each of the first memory device and the second memory device is a double data rate memory device.
